(19) United States
(12) Patent Application Publication
(10) Pub. No.: US 2005/0274743 A1
(43) Pub. Date: Dec. 15, 2005

(54) Portable foaming apparatus

(75) Inventor: Brent Barefoot, Mathews, VA (US)

Correspondence Address: WILLIAMS MULLEN, FOUNTAIN PLAZA THREE, SUITE 200, 721 LAKEFRONT COMMONS, NEWPORT NEWS, VA, 23606, US

(73) Assignee: SOLO, Inc.

(21) Appl. No.: 11/138,784

(22) Filed: May 26, 2005

Related U.S. Application Data
(60) Provisional application No. 60/574,469, filed on May 26, 2004.

(51) Int. Cl. B67D 5/08; B67D 5/14; B67D 5/58

(52) U.S. Cl. 222/190

(57) ABSTRACT

The portable foaming device includes a vessel for containing liquids, foaming agents and compressed gas. The compressed gas forces the liquid/foaming agent mixture from the vessel by means of a tube which is controlled by a valve. The liquid/foaming agent mixture is formed into a foam by means of a gas conduit formed in the tube. The compressed gas can be maintained by means of a pump or an air compressor.

### CROSS REFERENCE TO RELATED APPLICATIONS

The present application claims priority from U.S. Provisional Application Ser. No. 60/574,469, filed May 26, 2004.

### BACKGROUND OF THE INVENTION

1. Field of the Invention

The invention relates to a liquid dispensing device and more particularly to a portable liquid dispensing device which dispenses foam.

2. Description of Related Art

Many types of liquid dispensing devices exist. In previous devices, a liquid is turned into a foam by agitating a container of fluid to form foam within a container. The foam is then dispensed from the container. Materials in a liquid state which are transmuted into a foam have a wide variety of uses in commerce, industry agriculture and many other fields. Typically, a liquid is sprayed to clean surfaces, protect plants, animals and people from pests and eliminate weeds or noxious vegetation. In many cases the spay formula is less effective than desired as it is affected by light breezes and gravity. Foamed material has numerous advantages. Foamed agents work over an extended period of time. Foamed materials are less likely to drift in light breezes and are inherently efficient as less material is lost to drippage, drift and run-off. This provides both a favorable environmental and economic impact, as well as, increasing the efficiency of the formula.

Foaming devices known in the art are often complex, expensive, difficult to manufacture, not easily adapted to existing products and frequently require special mixing chambers to produce the foam.

An object of the present invention is to provide a foaming apparatus which automatically creates foam from a foaming agent.

Another object of the present invention is to provide a foaming apparatus which can be does not require manual agitation to form foam.

Another object of the present invention is to provide a foaming apparatus which can be adapted to existing products.

An object of the present invention is to provide a foaming apparatus which is simple to manufacture and use.

Finally, it is an object of the present invention to accomplish the foregoing objectives in a simple and cost effective manner.

### SUMMARY OF THE INVENTION

The present invention addresses these needs by providing a device for forming foam from a foamable fluid and for dispensing the formed foam. The device includes a tank for holding the foamable fluid. The tank is preferably made from a substantially rigid, fluid impermeable material. The tank is preferably cylindrical in shape as is common for liquid dispensers but may be of any shape appropriate for the intended use. The device further includes a gas introduction device such as a pump or air compressor, for introducing a compressed gas into the tank. The device further includes a foam conduit for transporting the formed foam from the tank. The foam conduit is preferably a pressure hose and can be made from a single length of hose or can include several sections. The foam conduit can be of any appropriate cross-sectional shape but is preferably round or oval. The device additionally includes a gas conduit for allowing the compressed gas to enter the foam conduit such that the compressed gas mixes with the foamable fluid to form foam. The gas conduit is one or more openings formed in the foam conduit such that the opening(s) is located within the compressed gas introduced into the tank. The gas conduit can be of any appropriate shape but is preferably round or oval. The device preferably includes an apparatus for controlling the flow of foam from the tank such as a nozzle or valve whereby flow can be completely stopped as needed. The device may also include an apparatus for directing the foam such as a wand connected to the nozzle or valve.

### BRIEF DESCRIPTION OF THE DRAWINGS

A more complete description of the subject matter of the present invention and the advantages thereof, can be achieved by the reference to the following detailed description by which reference is made to the accompanying drawings in which:

FIG. 1 is a side view of the preferred embodiment of the present invention;

FIG. 2 is a cross sectional view of the preferred embodiment of the present invention taken across line IA;

FIG. 3 is an exploded cross-sectional view of the portion of the preferred embodiment of the present invention indicated by line III in FIG. 1a;

FIG. 4a is a partial side view of the conduit used in the preferred embodiment of the present invention;

FIG. 4b is a cross-sectional view of the conduit used in the preferred embodiment of the present invention taken across line IVB;

FIG. 5a is a partial side view of the conduit used in an alternate embodiment of the present invention;

FIG. 5b is a cross-sectional view of the conduit used in an alternate embodiment of the present invention taken across line VB;

FIG. 6a is a partial side view of the conduit used in an alternate embodiment of the present invention;

FIG. 6b is a cross-sectional view of the conduit used in an alternate embodiment of the present invention taken across line VIB;

FIG. 7 is a cross-sectional view of an alternate embodiment of the present invention;

FIG. 8 is a cross-sectional view of an alternate embodiment of the present invention;

FIG. 9 is a cross-sectional view of an alternate embodiment of the present invention;

FIG. 10 is a side view of an alternate embodiment of the present invention;

FIG. 11 is an exploded cross-sectional view of the portion of an alternate embodiment of the present invention indicated by line III in FIG. 1a; and

FIG. 12 is an exploded cross-sectional view of the portion of an alternate embodiment of the present invention indicated by line III in FIG. 1a.

### ELEMENT LIST

22 tank
24 pressure hose
26 pump
28 nozzle
30 wand
32 air-tight connector
34 gas conduit
36 lid
38 hose connection port

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention.

The present invention is a foaming apparatus, specifically, a portable foaming device that creates a pressurized foam and discharges the foam in a controlled manner through use of compressed air within a vessel containing foamable material.

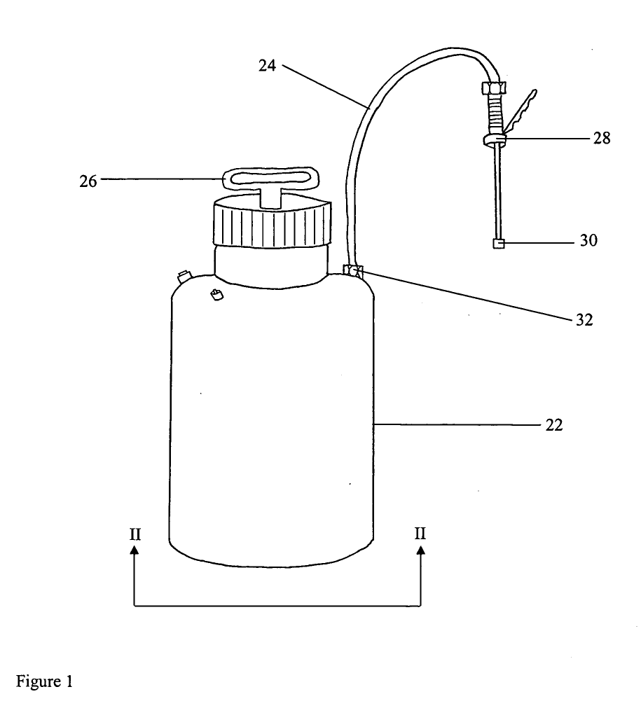

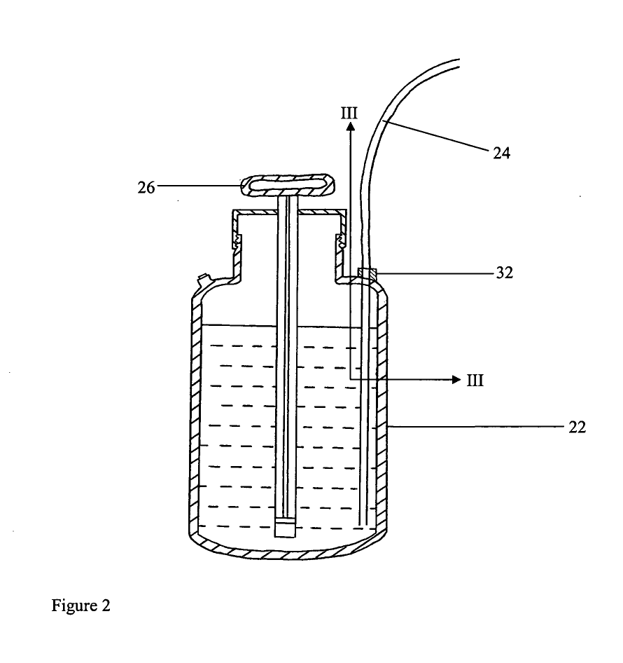

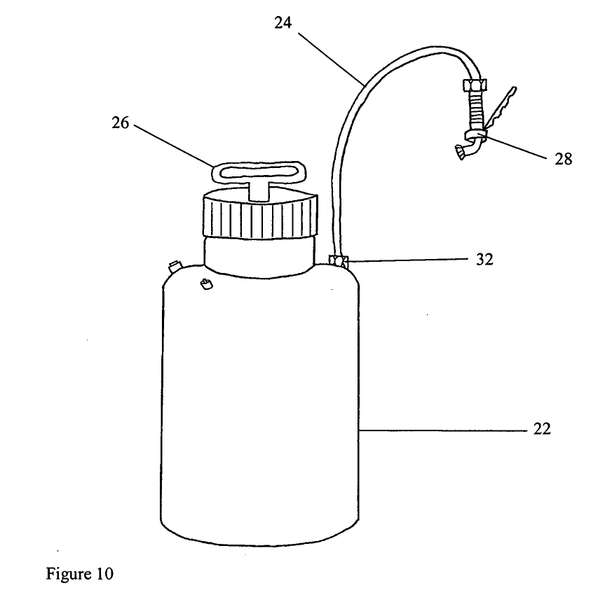

FIGS. 1-4b show the preferred embodiment. A generally cylindrical tank 22 is constructed from a substantially rigid material which is capable of containing a liquid formula, which includes a foaming agent, and compressed gas. One end of a pressure hose 24 extends into the interior of the tank 22 through an air-tight connector 32. This end of the pressure hose 24 extends all the way through the liquid formula so that it remains in the liquid formula as the volume of liquid formula decreases. The opposite end of the pressure hose 24 is connected to a nozzle 28 which controls flow of the liquid formula from within the tank 22. A wand 30 can be connected to the nozzle 28 for greater control of the exiting foamed liquid. FIG. 10 shows the present invention used with just a nozzle 28. The lid of the tank 22 preferably includes or provides for the inclusion of a pump 26 for compressing the gas inside the tank 22.

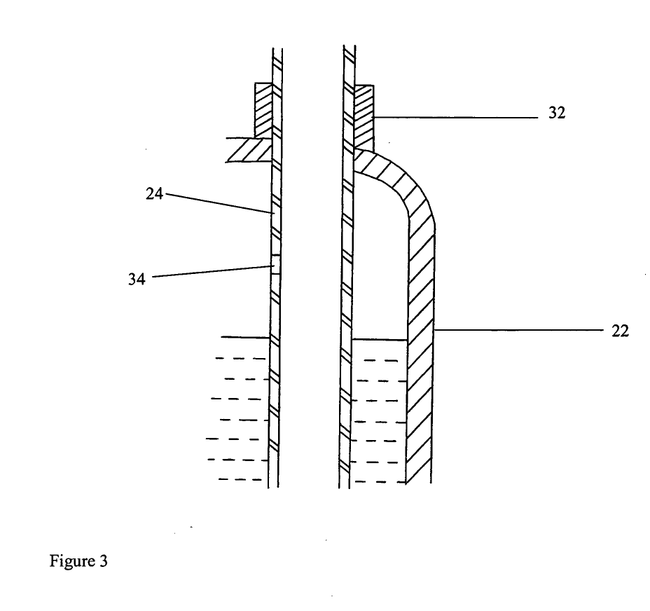

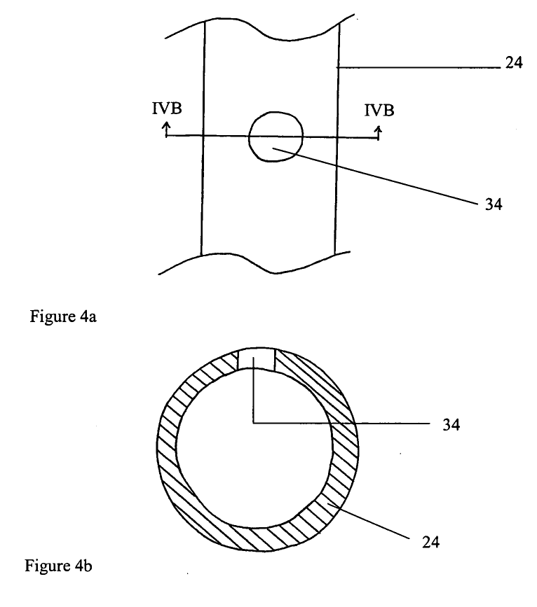

FIGS. 3, 4a and 4b show the apparatus which causes the liquid formula to become foam. The pressure hose 24 includes a gas conduit 34 on the portion of the pressure hose 24 which extends into the tank 22. The gas conduit 34 allows compressed gas inside the tank 22 to enter the pressure hose 24 as the liquid formula is allowed to exit the tank 22. Mixing the compressed gas with the exiting liquid formula causes the liquid formula to become a foam as it travels through the pressure hose 24 such that a foam exits the nozzle 28 or wand 30.

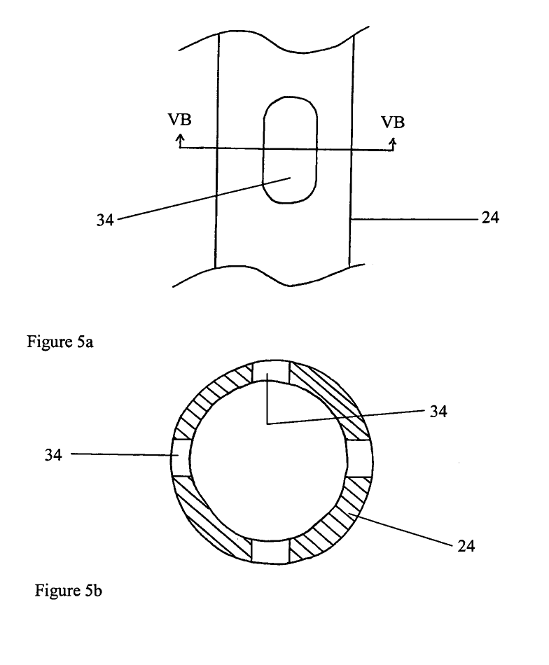

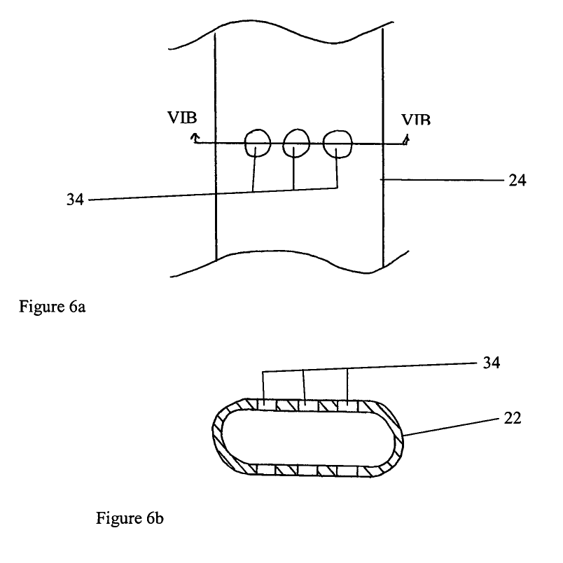

While the preferred embodiment of the present invention shows the use of a single, round gas conduit 24, as shown in FIGS. 5a and 5b, the gas conduit 34 can be a shape other than round and multiple gas conduits 34 can be formed in the pressure hose 24. And, as shown in FIGS. 6a and 6b, the gas conduits 34 need not be spaced equally around the pressure hose 24. Further, while the preferred embodiment shows a round pressure hose 24, the pressure hose 24 can be of other shapes, such as the oval shape shown in FIG. 6b.

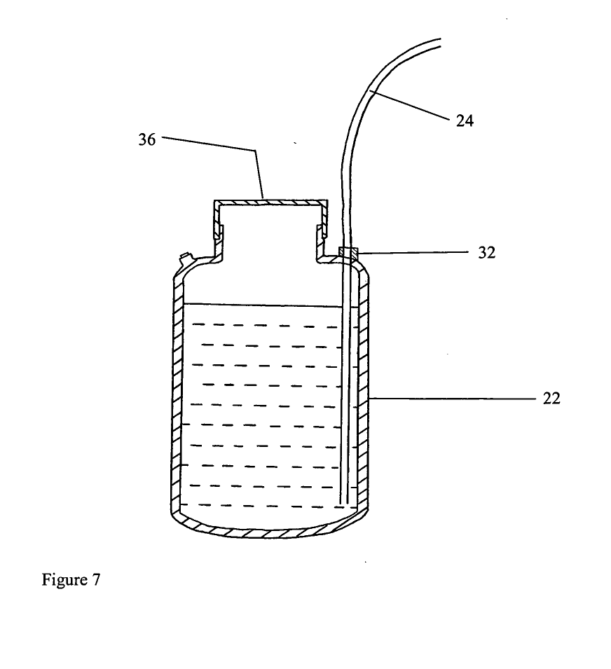

In an alternate embodiment shown in FIG. 7, the tank 22 may use an alternate means for providing compressed gas into the tank 22. In this embodiment, instead of a pump 26, an air compressor (not shown) can be used to compress the gas inside the tank 22. The tank 22 either includes a lid 36 with an air-tight connection or an integral lid.

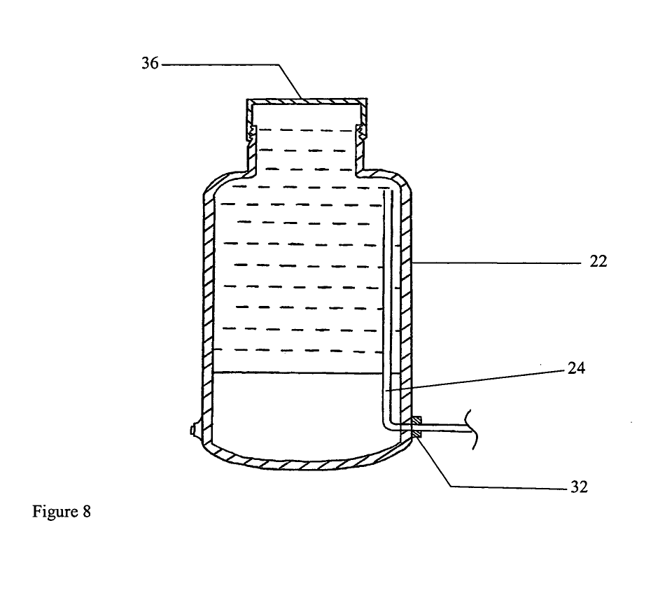

In another alternate embodiment shown in FIG. 8, instead of introducing compressed gas into the upper portion of the tank 22, compressed gas is introduced into the bottom of the tank 22. In this embodiment, the pressure hose 24 also enters the tank 22 at the bottom through an air-tight connector 32 and extends through the liquid formula. As the liquid formula exits the tank 22, the compressed gas forces the remaining liquid formula into the upper portion of the tank 22.

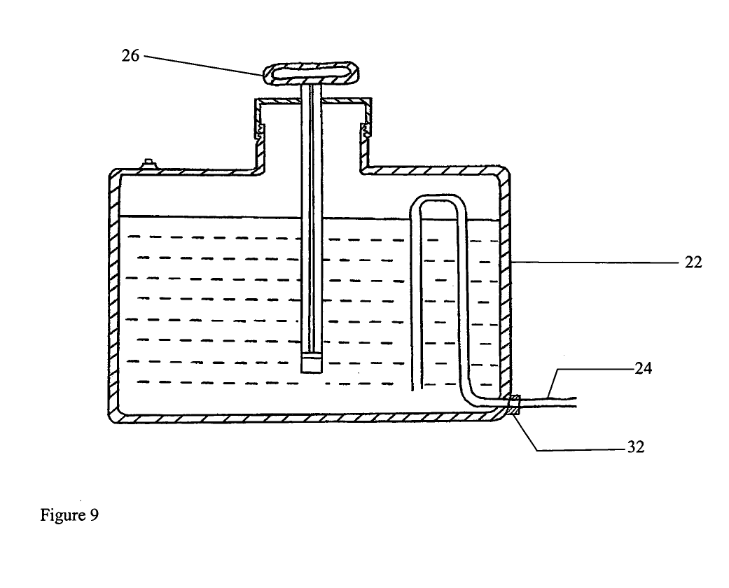

FIG. 9 shows another alternate embodiment of the present invention. In this embodiment, a square or rectangular tank 22 is used. Additionally, a handle activated pump 26 is provided for introducing compressed gas into the tank 22. In this embodiment, the pressure hose 24 enters through an air-tight connector 32 at the lower portion of the tank 22 and winds around inside the tank 22 to extend into the liquid formula.

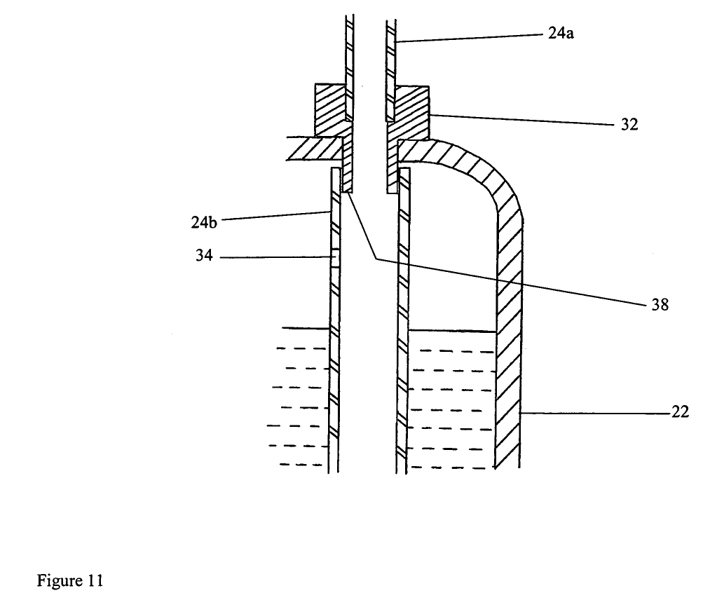

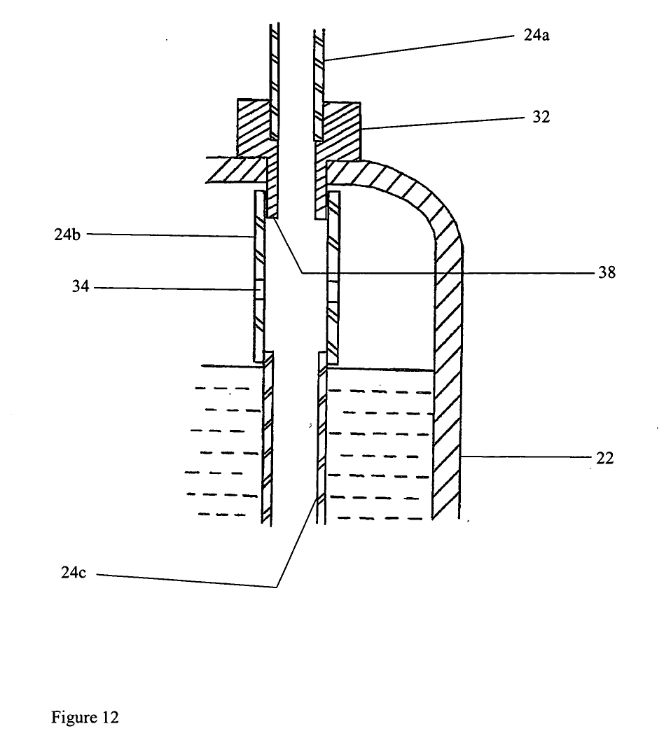

In further alternate embodiments shown in FIGS. 11 and 12, the pressure hose 24, shown as a single hose in the preferred embodiment, can consist of multiple portions. As shown in FIG. 11, one portion 24a of pressure hose 24 extends into and connects with the air-tight connector 32. The air-tight connector 32 includes a hose connection port 38 which extends into the tank 22. A second portion 24b of the pressure hose 24 attaches to the hose connection port 38 and extends into the liquid formula. This portion 24b includes at least one gas conduit 34. In the alternate embodiment shown in FIG. 12, the pressure hose 24 includes the external portion 24a as described for FIG. 11 as well as the hose connection port 38 which extends into the tank 22. In this embodiment, the second portion 24b of the pressure hose 24 attaches to the hose connection port 38 and to a third portion 24c of the pressure hose 24. The second portion 24b of the pressure hose 24 includes at least one gas conduit 34. The third portion 24c of the pressure hose 24 extends through the liquid formula.

In use, a functional configuration employs a cylindrical tank 22 having a built-in hand pump 26. The liquid formula is placed in the tank 22 and the tank is closed in an air-tight fashion. The pump 26 is activated to insert compressed air into the tank 22. As shown in FIG. 11, a pressure hose 24 is used which consists of two sections 24a,24b. The pressure hose 24 is round in cross-section and the portion 24b inside the tank 22 has an internal diameter of 0.23 inches. The portion 24a of the pressure hose 24 outside the tank 22 has an internal diameter of 0.20 inches. Two round gas conduit openings 34 are located in the portion 24b of the pressure hose 24 which is surrounded by the compressed gas. The openings 34 have a diameter of 0.0395 inches. The portion 24a of the pressure hose 24 outside the tank 22 connects to a nozzle 28 which has an exit diameter of 0.25 inches.

While the preferred embodiment of the present invention shows one specific design for a foam dispensing apparatus, other designs are considered within the scope of this invention. The tank 22 may be of any shape capable of containing the liquid formula and compressed gas and which allows for the insertion of a pressure hose 24 or other means for transporting the liquid formula from the tank 22 in foam form. The pressure hose 24 may be of any appropriate shape but must extend into the liquid formula and preferably extends completely through the liquid formula. Pumps and air compressors have been disclosed for providing compressed gas into the tank 22 but other means for providing compressed gas may be used. The gas conduit 34 may be of any appropriate shape which allows the compressed gas to enter the pressure hose 24. More than one gas conduit 34 may be used and they may be distributed evenly or unevenly around the pressure hose 24. The gas conduits 34 must be located in the portion of the tank 22 which holds the compressed gas.

Many improvements, modifications, and additions will be apparent to the skilled artisan without departing from the spirit and scope of the present invention as described herein and defined in the following claims.

1. A device for forming foam from a foamable fluid and for dispensing the formed foam, comprising:
a tank capable of containing the foamable fluid;
a gas introduction means for introducing a compressed gas into the tank;
a foam conduit means for transporting the formed foam from the tank;
a gas conduit means for allowing the compressed gas to enter the foam conduit means such that the compressed gas mixes with the foamable fluid to form foam.

2. The device as set forth in claim 1 wherein the tank is made from a substantially rigid, fluid impermeable material.

3. The device as set forth in claim 1 wherein the gas introduction means is selected from the group consisting of a pump and an air compressor.

4. The device as set forth in claim 1 wherein the foam conduit means is a pressure hose.

5. The device as set forth in claim 4 wherein the pressure hose consists of a plurality of sections.

6. The device as set forth in claim 4 wherein the pressure hose has a cross-sectional shape selected from the group consisting of round and oval.

7. The device as set forth in claim 1 wherein the gas conduit means comprises at least one opening formed in the foam conduit means such that the opening is located within the compressed gas introduced into the tank.

8. The device as set forth in claim 7 wherein the at least one opening has a shape selected from the group consisting of round and oval.

9. The device as set forth in claim 1 wherein the gas conduit means comprises a plurality of openings formed in the foam conduit means such that the opening is located within the compressed gas introduced into the tank.

10. The device as set forth in claim 9 wherein each of the plurality of openings has a shape selected from the group consisting of round and oval.

11. The device as set forth in claim 1 further comprising a flow control means for controlling the flow of the formed foam.

12. The device as set forth in claim 11 wherein the flow control means can be switched between allowing flow of the formed foam and preventing flow of the formed foam.

13. The device as set forth in claim 11 wherein the flow control means is a nozzle.

14. The device as set forth in claim 1 further comprising a directional control means for directing the flow of the formed foam.

15. The device as set forth in claim 14 wherein the directional control means is a wand.
